(19) United States
(12) Patent Application Publication
(10) Pub. No.: US 2026/0225702 A1
(43) Pub. Date: Aug. 6, 2026

(54) FUEL CELL WATERCRAFT

(71) Applicant: SUZUKI MOTOR CORPORATION, Hamamatsu-shi (JP)

(72) Inventor: Hideyuki SHISHITANI, Hamamatsu-shi (JP)

(73) Assignee: SUZUKI MOTOR CORPORATION, Hamamatsu-shi (JP)

(21) Appl. No.: 19/392,973

(22) Filed: Nov. 18, 2025

(30) Foreign Application Priority Data
Feb. 3, 2025 (JP) 2025-016046

(51) Int. Cl. B63H 21/17; B63H 21/00

(52) U.S. Cl. CPC B63H 21/17; B63H 2021/003

(57) ABSTRACT

There is provided a cooling system for a fuel cell watercraft without the necessity of a seawater pipe or a seawater pump. The fuel cell watercraft includes: an electric motor serving as a power source to generate propulsive force for a hull; a fuel cell module for generating electric power to be supplied to the electric motor; and a cooling system for cooling the fuel cell module. The cooling system includes a cooling chamber with an intake port and a discharge port that penetrate a bottom portion of the hull, a heat exchanger arranged so as to be immersed in water that is taken into the cooling chamber, and a circulation line and a pump for circulation of coolant between the heat exchanger and the fuel cell module.

### CROSS-REFERENCE TO RELATED APPLICATION

This Application claims priority from Japanese Patent Application No. 2025-016046 filed February 3, 2025, which is incorporated herein by reference in its entirety.

### FIELD

The present invention relates to fuel cell watercraft.

### BACKGROUND

Fuel cells are power generators that generate electric power through an oxidation-reduction reaction between hydrogen fuel and oxygen in the air. During power generation, heat and water are generated. For a polymer electrolyte fuel cell (PEFC), which uses a polymer electrolyte membrane as an electrolyte, the operating temperature must be maintained at 80 degrees Celsius or less, and a cooling system is required for temperature regulation.

The cooling systems for a watercraft include a system that uses seawater as cooling water. For example, a cooling system for a watercraft with an internal combustion engine disclosed in JP 2015-131613 A is an indirect cooling system including a seawater line and a cooling water line (freshwater line) that is separate from the seawater line, with a heat exchanger installed between the seawater line and the fresh water line.

Prior Art JP 2015-131613 A

In the case of fuel cell watercraft, an indirect cooling system is basically adopted, because the seawater directly introduced into the cooling water line causes problems such as short circuits. However, conventional indirect cooling systems require a pipe and a pump for each of the seawater line and the cooling water line (fresh water line), resulting in high cost for relatively small fuel cell modules.

The present invention has been made in view of the above problem of the conventional technology, and an object of the present invention is to provide a cooling system for a fuel cell watercraft that does not require a seawater pipe nor a seawater pump.

### SUMMARY OF THE INVENTION

In order to accomplish the above object, the present invention relates to a fuel cell watercraft including: an electric motor serving as a power source to generate propulsive force for a hull; a fuel cell module for generating electric power to be supplied to the electric motor; and a cooling system for cooling the fuel cell module. The cooling system includes a cooling chamber with an intake port and a discharge port that each penetrate a bottom portion of the hull, a heat exchanger arranged so as to be immersed in water that is taken into the cooling chamber, and a circulation line and a pump for a coolant to circulate between the heat exchanger and the fuel cell module.

The fuel cell watercraft according to the present invention includes the cooling system as described above. Accordingly, in the heat exchanger immersed in the water that has flowed into the cooling chamber through the intake port that is present under the draft, the fuel cell module is cooled by the coolant in the circulation line that is cooled by the heat exchange with the water. With the propulsion of the fuel cell watercraft, external water flows into the cooling chamber through the intake port and flows out through the discharge port, which maintains the water temperature inside the cooling chamber close to the temperature of the external water.

Moreover, with the above configuration, it is possible to construct a simple cooling system at low cost without the need for a seawater pipe or a seawater pump even though the cooling system is the indirect cooling system where external water, such as seawater, does not circulate in the circulation line. Moreover, existing storage space included in a hull, such as a fish tank, can be used as a cooling chamber, which makes it possible to advantageously place the cooling system in an existing hull at low cost.

### BRIEF DESCRIPTION OF THE DRAWINGS

FIG. 1 is a plan view showing a fuel cell watercraft according to an embodiment of the present invention;

FIG. 2 is a sectional side view showing the fuel cell watercraft according to the embodiment of the present invention; and

FIG. 3 is a sectional side view of an essential part showing an intake port and a discharge port of a cooling chamber.

### DETAILED DESCRIPTION

An embodiment of the present invention is described below in detail with reference to the drawings.

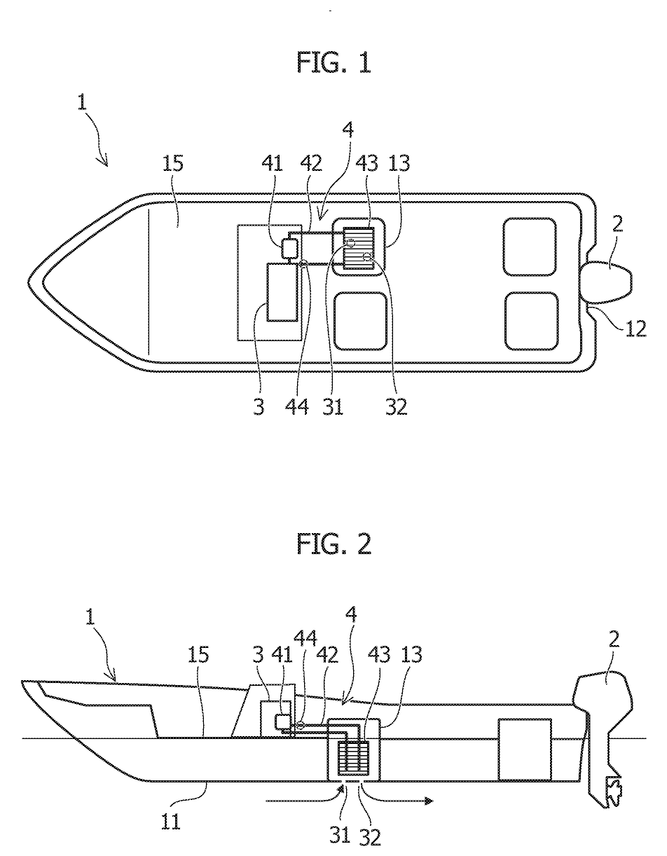

In FIGS. 1 and 2, a fuel cell watercraft 1 according to the embodiment of the present invention includes an electric outboard motor 2 that includes a propeller and an electric motor for generating propulsive force for a hull, the electric outboard motor 2 being mounted on a rear portion 12 of the hull so that the fuel cell watercraft 1 is steerable. The fuel cell watercraft 1 also includes a fuel cell module 3 for generating electric power that is supplied to the electric outboard motor 2, and a cooling system 4 for the fuel cell module 3. Here, a propulsion device may be other than an outboard motor, such as a water jet.

The fuel cell module 3, which is arranged on a hull deck 15, includes a fuel cell stack, hydrogen-based equipment such as a hydrogen circulation pump, and oxygen-based equipment such as an air filter and a blower. The fuel cell module 3 constitutes a fuel cell system together with such component members as electrical equipment such as a battery and a power conversion system, a hydrogen fuel tank, and a control unit, which are not shown. The fuel cell stack is formed by stacking a large number of unit cells each constituted of a membrane electrode assembly (MEA), a hydrogen-side separator stacked on one side of the MEA through a gas diffusion layer, and an air-side separator stacked on the other side of the MEA through another gas diffusion layer. A coolant channel is provided between each unit cell.

The cooling system 4 includes a circulation line 42 and a circulation pump 41 for circulation of the coolant between the fuel cell module 3 and a heat exchanger 43. The circulation line 42 is equipped with a temperature sensor 44 that detects the temperature of the coolant. The heat exchanger 43 is arranged inside a cooling chamber 13.

The cooling chamber 13 includes an intake port 31 and a discharge port 32 penetrating a bottom portion 11 of the hull to take in external water, such as seawater, through the intake port 31 and the discharge port 32. When the fuel cell watercraft 1 is in a stopped state, the water level in the cooling chamber 13 coincides with a draft line.

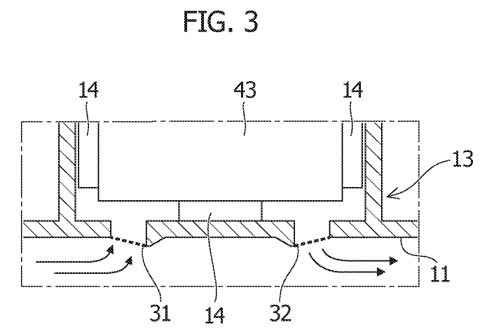

The heat exchanger 43 includes a main pipe constituting a portion of the circulation line 42 and a heat transfer plate or a fin for increasing a heat exchange area of the heat exchanger 43. The heat exchanger 43 is supported inside the cooling chamber 13 so as to be sufficiently immersed in water while a flow of the water taken in the cooling chamber 13 is secured. For example, as shown in FIG. 3, the heat exchanger 43 may be supported on side wall portions or the bottom portion of the cooling chamber 13 via spacers 14, or may be supported on upper edge portions of the side walls by brackets, not shown, and be installed such that the heat exchanger 43 can be removed as necessary.

As shown in FIG. 3, in order to promote water intake and water discharge from the intake port 31 and the discharge port 32 in the cooling chamber 13 by propulsion of the hull, the intake port 31 preferably has an inclination directed forward in an advancing direction and the discharge port 32 preferably has an inclination directed rearward in the advancing direction. In the illustrated example, the intake port 31 and the discharge port 32 have inclined perforated plates (mesh structure) provided to prevent foreign objects from entering. However, in addition to, or in place of, such inclinations, a protruding edge may be provided at an edge portion on the rear side of the intake port 31 in the advancing direction, and another protruding edge may be provided at the edge portion on the front side of the discharge port 32 in the advancing direction.

It is preferable that the inclinations or protruding edges of the intake port 31 and the discharge port 32 as described above are formed symmetrically in the front-rear direction of the hull so that the amount of water intake and the amount of water discharge associated with the propulsion of the hull are equal. Moreover, as schematically shown in FIG. 1, in order to promote water intake and water discharge by the propulsion of the hull as well as by rolling of the hull during propulsion or anchorage, the intake port 31 and the discharge port 32 are preferably arranged to be offset in the front-rear direction and also in the width direction.

In the thus-configured fuel cell watercraft 1, the fuel cell module 3 is started using electric power from an auxiliary battery, not shown. The electric power generated by the fuel cell module 3 charges a main battery and the auxiliary battery, and the electric power is supplied from the main battery or the fuel cell module 3 to the electric outboard motor 2, thereby generating the propulsive force.

As the fuel cell module 3 generates electric power, the temperature of the coolant in the circulation line 42 increases. When the temperature sensor 44 detects the temperature increase, the circulation pump 41 is activated, and the heat exchanger 43 performs heat exchange with the water in the cooling chamber 13 to cool the coolant in the circulation line 42. As a result, the temperature of the fuel cell module 3 is maintained within a target temperature.

The amount of water in the cooling chamber 13 is sufficiently greater than the amount of coolant in the circulation line 42. In addition, as the fuel cell watercraft 1 travels, external water from the intake port 31 is taken into the cooling chamber 13 and is discharged to the outside through the discharge port 32. As a result, while electric power necessary for the travel of the fuel cell watercraft 1 is generated (while heat is generated), water intake and water discharge, into and from the cooling chamber 13 (water exchange), is promoted, so that the water temperature in the cooling chamber 13 is held close to the external water temperature.

Therefore, it is possible to construct a cooling system constituted of only the small circulation line 42, between the fuel cell module 3 and the heat exchanger 43 inside the cooling chamber 13, and the single circulation pump 41, without the need for a seawater pipe or a seawater pump even though the cooling system is an indirect cooling system in which external water, such as seawater, does not circulate in the circulation line.

Moreover, existing storage space included in a hull, such as a fish tank, can be used as a cooling chamber, which makes it possible to add the cooling system to an existing hull at low cost. Furthermore, since the heat exchanger 43 in the vicinity of the fuel cell module 3 completes the cooling system, the fuel cell system including the cooling system can be removed and stored when the fuel cell watercraft 1 is not in use.

Although an embodiment of the present invention has been described in the foregoing, the present invention should not be limited to the embodiment disclosed, and various modifications and changes are further possible within the scope of the present invention based on the technical ideas of the present invention.

What is claimed is:

1. A fuel cell watercraft comprising:
an electric motor serving as a power source to generate propulsive force for a hull;
a fuel cell module for generating electric power to be supplied to the electric motor, and
a cooling system for cooling the fuel cell module,
wherein the cooling system includes:
a cooling chamber with an intake port and a discharge port that each penetrate a bottom portion of the hull,
a heat exchanger arranged so as to be immersed in water that is taken into the cooling chamber, and
a circulation line and a pump for circulation of coolant between the heat exchanger and the fuel cell module.

2. The fuel cell watercraft according to claim 1, wherein, to promote water intake from the intake port and water discharge from the discharge port by propulsion of the hull, the intake port and the discharge port are configured such that
the intake port has an inclination directed forward in an advancing direction and the discharge port has an inclination directed rearward in the advancing direction, or
the intake port has a protruding edge at an edge portion on a rear side in the advancing direction and the discharge port has a protruding edge at the edge portion on a front side in the advancing direction.

3. The fuel cell watercraft according to claim 2, wherein the inclinations of the intake port and the discharge port, or the protruding edges of the intake port and the discharge port are formed symmetrically in a front-rear direction of the hull.

4. The fuel cell watercraft according to claim 1, wherein the intake port and the discharge port are arranged offset in a front-rear direction and a width direction of the hull.
